(19) United States
(12) Patent Application Publication
(10) Pub. No.: US 2004/0202769 A1
(43) Pub. Date: Oct. 14, 2004

(54) Food supplement containing essential fatty acids and products therefrom

(76) Inventor: James F Stewart, Ontario (CA)

Correspondence Address: Theodore D Lienesch, Thompson Hine, 2000 Courthouse Plaza NE, 10 West Second Street, Dayton, OH, 45402-1758, US

(21) Appl. No.: 10/475,822

(22) PCT Filed: Apr. 23, 2002
(86) PCT No.: PCT/CA02/00566

Related U.S. Application Data
(60) Provisional application No. 60/285,240, filed on Apr. 23, 2001.

(51) Int. Cl. A23D 7/00

(52) U.S. Cl. 426/601

(57) ABSTRACT

This invention describes feed supplement, and processes which increase the amount of essential fatty acids in the milk, eggs, meat and other by-products from animals including dairy cattle, beef cattle, goats and poultry. The food supplement described herein includes specific fish meal, fish oil, algae or plant dietary supplements combined with a natural ingredient/coating mixture, which can be either talc, clay or combinations; or mixtures of talc or clay with flax sprout powder to achieve enhanced levels of the essential fatty acids in the milk, eggs, meat and processed livestock products from animals fed this dietary supplement. In ruminants, the natural ingredient/coating mixture prevents microbial degradation of the essential fatty acids in the rumen stomach of the animals fed with this composition, thus providing more of the essential fatty acids to the animal, for their use. This in turn results in improved concentrations in the milk, meat and processed products from these animals. Poultry fed with this food supplement also have a higher concentration of essential fatty acids in their eggs and meat.

### FIELD OF THE INVENTION

This invention relates to a feed supplement, and processes which increase the amount of essential fatty acids in the milk, eggs, meat and other by-products from animals including dairy cattle, beef cattle, goats and poultry. In particular, the present invention relates to a feed supplement, which includes a natural ingredient that acts as a rumen bypass ingredient, which protects the fatty acids from being broken down in the rumen so that the ruminant can receive the beneficial effects of the feed or food supplement formulations. This natural ingredient in a feed supplement results in a higher concentration of essential fatty acids in the eggs and meat from poultry fed this feed supplement.

### BACKGROUND OF THE INVENTION

Essential fatty acids (EFAs) are required in human nutrition. There are two groups of essential fatty acids, omega-3 fatty acids and omega-6 fatty acids. Omega-3 fatty acids are found naturally in the oil of cold-water fish, such as mackerel, salmon, sardines, anchovies and tuna, or as extracted oil from plants, such as flaxseed, canola (rapeseed), or soybean. Examples of omega-3 fatty acids include docasahexaenioc acid (DHA), eicosapentenoic acid (EPA) and alpha linolenic acid. Omega-6 fatty acids are found in both animal and plant material. Plant sources include unprocessed, unheated vegetable oils such as corn, sunflower seed, safflower, soy, sesame, and cottonseed oils. They are also found in plant materials such as evening primrose, black current seeds and gooseberry oils as well as in raw nuts and seeds, legumes and leafy greens. Omega-6 fatty acids include linoleic acid and its derivatives, such as arachidonic acid (AA). There are also conjugated fatty acids such as conjugated linolenic acid (CLA).

These fatty acids are linked to a wide variety of beneficial health effects in documented intervention studies as essential constituents of cells, especially brain cells, nerve relay, retina, adrenal glands, and reproductive cells. Long chain polyunsaturates (LCP's) such as DHA/EPA have health benefits for the heart, skin, immune and inflammatory diseases, attention deficit disorders and infant development. There are also a number of new studies underway that show benefits in preventing Alzheimers', dementia, and colorectal cancers.

There have been a number of patents granted outlining the benefits from specific omega fatty acids present in food and/or supplements. Several patents have also been granted for the enrichment of foods that are normally low or deficient in omega 3/6 and LCP's. For example, U.S. Pat. No. 5,932,257 (Wright et al.) relates to DHA being produced in cow's milk through the feeding of cold-water fish meal to cows, using a feather meal based feed supplement. The feather meal used according to this prior art reference is used as an inhibitor of microbial degradation of DHA in the rumen of the dairy cattle. U.S. Pat. Nos. 4,911,944 and 5,290,573 also disclose the use of feed supplements containing fish meal combined with animal bi-products eg. feather meal, bone meal and the like. A number of patents have also been granted for the elevation of omega 3 in eggs using flax meal or algae/DHA feed supplements in chickens.

A ruminant is an animal which possesses a complex stomach consisting of four morphologically distinct compartments. These compartments are rumen, reticulum, omasum and abomasum. The former two are derived from the terminal portion of the esophagus, and only the latter two are considered to be a genuine stomach. After passing the first two compartments, the food is returned to the mouth. The rumen and the reticulum are fermentation compartments wherein Ophryoscolex Diplodinium and Plectridium cellulolyticum are commensal, and the digestion of the feed (vegetable tissues) is conducted by cellulase, amylase, or cellobiose secreted by these microorganisms (digestive symbiosis).

In ruminant animals like cattle or sheep, there is a problem that occurs when a biologically active substance is, for instance, orally administered. A substantial part of the substance is decomposed to ammonia or carbon dioxide gas by the microorganisms in the rumen, making it difficult or impossible for the animal to effectively utilize all of the administered proteins, amino acids or fatty acids contained in the active substance. Thus, a ruminant only receives the benefit of a portion of the nutrients fed to it and loses a portion for the support and formation of rumen microorganisms. While the nutrients contained in feed clearly contribute to the ruminant's sustenance, another source of nutrition for ruminants is the protein derived from those microorganisms in the rumen which are passed to the lower stomachs. Accordingly, it is important to maintain the microorganism population in the rumen in order to provide a constant source of this protein.

When special nutrients or drugs which must be absorbed or metabolized are administered to ruminants it is important to protect these substances from the environmental conditions of the first stomach: i.e., from the decomposition by microorganisms and from the influence of weakly acidic or weakly alkaline pH, so that the substance can be maintained intact until it reaches the intended digestive or absorptive site. Namely, it is desirable that certain nutrients and drugs pass through the rumen to the omasum without being affected by microorganisms, digestion being conducted in the abomasum with the digested feed being absorbed by the small intestine. As noted above with U.S. Pat. No. 5,932,257, this in part was accomplished by including within the composition an inhibitor of microbial degradation of DHA, in this patent feathermeal as the inhibitor. However, as noted above, this approach is not preferred, as the ruminant microorganisms are important and must be maintained. Other methods of protecting active components from degradation in the rumen have been described, e.g., in Canadian Patent application 2,147,432, which use hardened animal and plant oils and fats and fatty acid esters to protect the active ingredient. There are problems, however, encountered with this method, as it is often necessary to include within the active ingredient other special ingredients which will assist in the degradation of the ruminant bypass product, once the product has passed into the second and third stomachs for digestion. Thus, there is a need for a ruminant bypass ingredient which will assist in protecting essential fatty acids from attack by the microorganisms in the ruminant so that these fatty acids are available for use by the animal, once they have passed into the third and fourth stomaches of the ruminant complex stomach system.

A number of Patents have also been granted for the elevation of omega 3 in eggs using flax meal or algae/DHA feed supplements in chickens. Flax in the case of most livestock feeds also acts as a laxative and can be a feeding deterrent. While flax seed is an excellent source of alpha linolenic acid, i.e. in the order of 15 g/100 g, whole flax seed passes through the body almost entirely unconverted; ground flax seed on the other hand rapidly losses its alpha linolenic acid content and does not store well in terms of LNA content. In terms of algae (DHA fermented concentrates), these feed and food mixes are produced via genetic recombinant technology, which has limited consumer favour in most markets.

Prior art feed formulas have a number of deficiencies on a practical basis. For example, fish meal/feather meal feed supplements are very unpalatable and can be a feeding deterrent to livestock such as cows, and only limited amounts of DHA can be achieved in the milk. Also, the use of animal by-products, i.e., blood meal/feather meal, have been banned in most countries to prevent the spread of infectious diseases. Moreover, obtaining elevated levels of beneficial compounds such as omega 3 fatty acids in meat or livestock by-products (milk, and milk processed products such as cheese, cream and the like), has been difficult to achieve. As noted above, this is because the stomach(s) of livestock (animals), eg. the rumen in dairy cows, breaks down long chain polyunsaturates eg. DHA/EPA, thereby preventing the elevation of natural sources/LCP's in livestock, livestock by-products (eg. milk) or processed fractions. There is also thus a need to provide a food supplement that addresses the flavour and stability problems of the prior art supplements.

### SUMMARY OF THE INVENTION

This invention relates to a feed supplement, and processes which increase the amount of essential fatty acids in the milk, eggs, meat and other by-products from animals including dairy cattle, beef cattle, goats and poultry. In particular, the present invention relates to a feed supplement, which includes a natural ingredient that acts as a rumen bypass ingredient, which protects the fatty acids from being broken down in the rumen so that the ruminant can receive the beneficial effects of the feed or food supplement formulations. This natural ingredient in a feed supplement results in a higher concentration of essential fatty acids in the eggs and meat from poultry fed this feed supplement.

It is an object of the present invention to provide a feed/food supplement that will provide a method of elevating beneficial components such as omega 3/6 fatty acids in livestock, animals, and their use in producing milk, meat, eggs and other livestock by-products as food, processed food products supplements, and ingredients whereby these new feed and food products and uses result in elevated amounts of beneficial omega 3/6 fatty acids, long chain polyunsaturates, nutraceuticals such as DHA/EPA/AA that have subsequent health processing and livestock husbandry benefits.

The uniqueness of the invention is the combination or known feeding dietary supplements containing cold-water fish meal and/or oil/plant/algae combined with the use of a natural ingredient/coating mix in a diet and feeding regime which results in elevated levels of beneficial omega fatty acids in the milk, meat, eggs and processed food products. The key omega 3/6 and LPC components of the supplement remain the same; only certain components vary in terms of dietary and taste needs for livestock.

Thus, according to the present invention, there is provided a feed additive for livestock comprising:

a) essential fatty acids; and

b) a natural ingredient selected from the group consisting of talc and clay wherein said natural ingredient is present in the feed in an amount sufficient to increase the concentration of the essential fatty acids in the milk, eggs or meat of the animal fed with the feed additive over a period of time.

In a further embodiment, there is also provided a method of producing milk, eggs or meat of animal which is enriched for essential fatty acids comprising feeding an animal a feed additive as defined in any of claims 1 to 8 in an amount sufficient to enhance the concentration of essential fatty acids in the milk, eggs or meat and collecting the milk, eggs or meat from said animal.

Also included in this invention is enriched milk and milk products produced from animals fed with the feed additive of the present invention.

Further, according to the present invention, there is provided meat and meat products produced from animals fed with the feed additive of the present invention.

### DETAILED DESCRIPTION OF THE INVENTION

This invention relates to a feed supplement, and processes which increase the amount of essential fatty acids in the milk, eggs, meat and other by-products from animals including dairy cattle, beef cattle, goats and poultry. In particular, the present invention relates to a feed supplement, which includes a natural ingredient that acts as a rumen bypass ingredient, which protects the fatty acids from being broken down in the rumen so that the ruminant can receive the beneficial effects of the feed or food supplement formulations. This natural ingredient in a feed supplement results in a higher concentration of essential fatty acids in the eggs and meat from poultry fed this feed supplement.

According to the present invention, there is provided a method of elevating beneficial components such as omega 3/6 fatty acids in livestock and other animals. This results in elevated levels of omega 3/6 fatty acids in the a milk, meat, eggs and other livestock by-products used as food, processed food products, supplements and ingredients. According to the present invention, the term “omega fatty acids” is meant to include omega-3 (or N-3) and/or omega-6 polyunsaturated fatty acids, such as docosahexaenoic acid (DHA), eicosapentaenoic acid (EPA), or precursors such as alphalinolenic acid (ALA), and linoleic acid and its derivates such as gamma linoleic acid (GLA) or conjugates such as conjugated linolenic acid and other beneficial fatty acids.

The omega fatty acids, which is in the feed additive, may be in concentrate form, which may contain 5 to 98% omega fatty acids, or it may be a component of an extract from a source known to contain the omega fatty acids. For example, it may be a component of an extract derive from fish, such as fish meal, flax, algae and the like. Some of these sources of omega fatty acids are commercially available and are combined with other nutrients known in the art. According to the present invention, a natural ingredient of either clay or talc, or mixtures, is fed to the animal with the omega fatty acid dietary supplement. Not being wanted to be bound by any particular theory, it is suggested that the talc or clay material coats the inner linings of the rumen to allow the omega fatty acid feed supplement to pass through the rumen with little or no microbrial degradation, thus allowing the full benefit of the feed to be utilized by the animal. It has also been suggested that the natural ingredient could be acting as a anti acid in the livestock stomach. This in particular may be the reason why the feed additive of the present invention is beneficial to chickens and results in an increased concentration of essential fatty acids in the resulting eggs and meat. Chickens, of course, are not rumens, however have been found to benefit from the feed additive of the present invention.

According to the present invention, the talc or clay natural ingredient is selected from the group consisting of magnesium silicate hydroxide, sodium bentonite, a member from the kaolinite group, a member from the montmorillonite/smectite group, a member of the illite group and a member of the chlorite group. These groups are defined below.

The Kaolinite Group has three members (kaolinite, dickite and nacrite) and a formula of Al₂Si₂O₅(OH)₄. The different minerals are polymorphs, meaning that they have the same chemistry but different structures (polymorph=many forms). The general structure of the kaolinite group is composed of silicate sheets (Si₂O₅) bonded to aluminum oxide/hydroxide layers (Al₂(OH)₄) called gibbsite layers. The silicate and gibbsite layers are tightly bonded together with only weak bonding existing between the s-g paired layers.

The Montmorillonite/Smectite Group is composed of several minerals including pyrophyllite, talc, vermiculite, sauconite, saponite, nontronite and montmorillonite. They differ mostly in chemical content. The general formula is (Ca, Na, H)(Al, Mg, Fe, Zn)₂(Si, Al)₄O₁₀(OH)₂—xH₂O, where x represents the variable amount of water that members of this group could contain. Talc's formula, for example, is:

Mg₃Si₄O₁₀(OH)₂. The gibbsite layers of the kaolinite group can be replaced in this group by a similar layer that is analogous to the oxide brucite, (Mg₂(OH)₄). The structure of this group is composed of silicate layers sandwiching a gibbsite (or brucite) layer in between, in an s-g-s stacking sequence. The variable amounts of water molecules would lie between the s-g-s-sandwiches.

The Illite (or the clay-mica) Group is basically a hydrated microscopic muscovite. The mineral illite is the only common mineral represented, however it is a significant rock forming mineral being a main component of shales and other argillaceous rocks. The general formula is (K, H)Al₂(Si, Al)₄O₁₀(OH)₂—xH₂O, where x represents the variable amount of water that this group could contain. The structure of this group is similar to the montmorillonite group with silicate layers sandwiching a gibbsite-like layer in between, in an s-g-s stacking sequence. The variable amounts of water molecules would lie between the s-g-s sandwiches as well as the potassium ions.

The Chlorite Group is not always considered a part of the clays and is sometimes left alone as a separate group within the phyllosilicates. It is a relatively large and common group although its members are not well known. These are some of the recognized members:

Amesite (Mg, Fe)₄Al₄Si₂)₁₀(OH)₈

Baileychlore (Zn, Fe+2, Al, Mg)₆(Al, Si)₄O₁₀(O, OH)₈

Chamosite (Fe, Mg)₃Fe₃AlSi₃O₁₀(OH)₈

Clinochlore (kaemmererite) (Fe, Mg)₃Fe₃AlSi₃O₁₀(OH)₈

Cookeite LiAl₅Si₃O₁₀(OH)₈

Corundophilite (Mg, Fe, Al)₆(Al, Si)₄O₁₀(OH)₈

Daphnite (Fe, Mg)₃(Fe, Al)₃(Al, Si)₄O₁₀(OH)₈

Delessite (Mg. Fe+2, Fe+3, Al)₆(Al, Si)₄O₁₀(O, OH)₈

Gonyerite (Mn, Mg)₅(Fe+3)₂Si₃O₁₀(OH)₈

Nimite (Ni, Mg, Fe, Al)₆AlSi₃O₁₀(OH)₈

Odinite (Al, Fe+2, Fe+3, Mg)₅(Al, Si)₄O₁₀(O, OH)₈

Orthochamosite (Fe+2, Mg, Fe+3)₅Al₂Si₃O₁₀(O, OH)₈

Penninite (Mg, Fe, Al)₆(Al, Si)₄O₁₀(OH)₈

Pannantite (Mn, Al)₆(Al, Si)₄O₁₀(OH)₈

Rhipidolite (prochlore) (Mg, Fe, Al)₆(Al, Si)₄O₁₀(OH)₈

Sudiote (Mg, Fe, Al)₄₋₅(Al, Si)₄O₁₀(OH)₈

Thuringite (Fe+2, Fe+3, Mg)₆(Al, Si)₄O₁₀(O, OH)₈

The term chlorite is used to denote any member of this group when differentiation between the different members is not possible. The general formula is X₄₋₆Y₄O₁₀(OH, O)₈. The X represents either aluminum, iron, lithium, magnesium, manganese, nickel, zinc or rarely chromium. The Y represents either aluminium, silicon, boron or iron but mostly aluminum and silicon.

According to the present invention, the natural ingredient of the present invention can be added in the barns to commercially available omega 3 feed supplements. In this embodiment, about 100 to 300 grams of the natural ingredient/coating mix (3-8% w/w) is added to about 3 kg of omega fatty acid feed supplement, either as a top dressing or as part of the total mixed ration, fed per day for each cow or beef cattle.

The total amount of feed fed per day will depend upon the size of the animal and the animal type.

According to the present invention, the ruminant bypass component of the present invention, the natural ingredient/coating mix, can be pre-mixed in the omega fatty acid feed supplement. In this embodiment an example of a omega fatty acid feed supplement is as follows:

| | Kg |
|---|---|
| Menhadden meal* | 150-300 |
| Herring meal | 150-300 |
| Or combinations of DHA/EPA microencapsulated | |
| Fish oil (30 EPA/20 DHA**) or combinations of | |
| NutraSprout (trademark) flax***/algae powder | |
| that maintain DHA/EPA | |
| Omega 3/6 levels the same as Menhadden | |
| and Herring meal. | |
| Barley | 150-250 |
| Soy hulls | 170-250 |
| HC plus Premix | 20-30 |
| (specific mineral pre-mix) | |
| Herring fish oil | 16-24 |
| Hiboot sale | 8-12 |
| Vitamin E | 4-6 |
| Mag Ox | 3.2-4.8 |
| Vitamin ADE | 1.6-2.4 |
| Apple flavour | 1.6-2.4 |

Natural (ingredients) coating mix magnesium silicate hydroxide (talc) and/or sodium bentonite and/or combinations of clay are added at a concentration of 3 to 8% w/w to the omega 3 feed ingredients/diet (i.e. 30 to 80 kg/1000 of the above feed ingredients).

* contains fish meal or oil from cold marine fish with a total DHA, EPA omega 3 and omega 6 content of the feed supplement being in the minimum order of 600, 400, 1000 and 540 mg/100 g respectively

** contains 225 mg/g of EPA and 150 mg/g of DHA and 400 mg/g of omega 3 and 4 mg/g of omega 6

*** contains 150 mg/g of omega 3 alpha linolenic acid or more

A typical test supplement comprises the following components on a % weight basis:

Minimum Guaranteed Analysis (Total Mix)

| | | | | |
|---|---|---|---|---|
| Crude Protein (min) | 38.2% | Zinc (actual) | 185 | mg/kg |
| *ECP from NPS (max) | 0.0% | Manganese | 185 | mg/kg |
| Crude Fat (min) | 6.1% | Copper (actual) | 75 | mg/kg |
| Crude Fiber (max) | 11.0% | Iodine (actual) | 2.9 | mg/kg |
| Calcium (min) | 3.3% | Iron (actual) | 500 | mg/kg |
| Phosphorous (min) | 1.7% | Cobalt (actual) | 0.85 | mg/kg |
| Sodium (actual) | 0.76% | Fluorine (max) | 100 | mg/kg |
| Magnesium (actual) | 0.6% | Vitamin A (min) | 25,300 | IU/kg |
| Potassium (actual) | 0.8% | Vitamin D3 (min) | 5,060 | IU/kg |
| Sulfur (actual) | 0.29% | Vitamin E (min) | 400 | IU/kg |
| Omega 3 | 35.80 g/kg | Omega 6 | 13.0 | g/kg |
| EPA | 17.0 g/kg | DHA | 38 | g/kg |

In a fitter embodiment of the present invention, when the omega 3 fatty acid dietary supplement is used in cattle, the supplement is as follows:

| | Kg. |
|---|---|
| Menhadden meal | 240 |
| Herring meal | 240 |
| Barley | 220 |
| Soy hulls | 232 |
| HC plus Premix | 25 |
| (specific mineral pre-mix) | |
| Herring fish oil | 20 |
| Hiboot salt | 10 |
| Vitamin E | 5 |
| Mag Ox | 4 |
| Vitamin ADE | 2 |
| Apple flavour | 2 |

Natural (ingredients) coating mix magnesium silicate hydroxide (talc) and/or sodium bentonite and/or combinations of clay are added at a concentration of 3 to 8% w/w to the omega 3 feed ingredients/diet (i.e. 30 to 80 kg/1000 of the above feed ingredients).

In further embodiments of the present invention, when the omega 3 fatty acid dietary supplement is used in goats, the supplement is as follows:

| | Kg. |
|---|---|
| Menhadden meal | 240 |
| Herring meal | 240 |
| Or combinations of DHA/EPA microencapsulated | |
| Fish oil (30 EPA/20 DHA) or combinations of | |
| NutraSprout (trademark) flax/algae powder that | |
| maintain DHA/EPA | |
| Omega 3/6 levels the same as Menhadden and | |
| Herring meal. | |
| Barley | 140 |
| Soy hulls | 232 |
| Alfalfa or quackgrass brome grass | 40 |
| Kelp | 40 |
| HC plus Premix (specific mineral pre-mix) | 25 |
| Hiboot salt | 10 |
| Vitamin E | 5 |
| Mag Ox | 4 |
| Vitamin ADE | 2 |
| Apple flavour | 2 |

Plus a natural (ingredient) coating mix containing 3 to 8% w/w (of 1-3 kg/day per goat) of talc/clay and/or sodium bentonite.

The key ingredients of the above feed supplement are sources of DHA/EPA/Omega 3/6, amounts of these omega 3/6 ingredients kelp, and alfalfa/grass mixtures.

In yet a further embodiment of the present invention, the natural ingredient/coating mix can be fortified with flax, usually in a ground meal and mixed or added to commercially available flax omega fatty acid supplements.

In this embodiment of the present invention, the natural (ingredient) coating mix may also contain mixtures of omega 3 fatty acid ingredients in the following range of ingredients:

Magnesium silicate hydroxide (talc) and/or sodium bentonite and/or combinations of clay 3 to 8% w/w (of 3 kg/day of total supplement) plus 20-25% alpha linolenic acid (ALA) flax/algae/plant source (including DHA/EPA) or combinations of DHA/EPA microencapsulated fish oil (30EPA/20DHA) on a 3 to 8% w/w (of 3 kg/day of total supplement).

In this embodiment of the present invention, the flax powder is prepared by a heat controlled process which removes the moisture without disrupting the cell wall, thus maintaining the omega 3 fatty acids and other essential fatty acids intact. A process for preparing such a flax powder has been described in previous U.S. Patent application 60/303,079, filed Jul. 7, 2001. The addition of the flax to the natural ingredient results in a product which is formable as a result of the stickiness of the overall product. Thus, this combination can be processed into a capsule or other product form, which results in a more easily handled product than when the clay or talc is used alone. The natural ingredient/coating mix, which is fortified with flax can be used in combination with any of the commercially available omega 3 fatty acid dietary supplements which are described in more detail above.

A total of 3.0 kg of omega 3 feed supplement is recommended either as a top dressing or as part of a total mixed ration per day to each cow/beef cattle; best results for cows were found feeding a total of 1.5 kg of feed supplement at each of two milking times, i.e. morning and evening. The same amount per day is recommended for goats, however, the supplement mix for goats is different from cows, as noted above.

In a further embodiment of the present invention, a flavouring ingredient is added to the supplement to improve its palatability and taste to the animals. Once such flavouring compound, which can be added, is apple flavouring. However, many other such flavoring ingredients could also be chosen.

A total of two to three weeks is usually required before levels of DHA reached a minimum of 0.2% of the fat content (see below) or 6 mg/100 g based on a 3% level of fat.

A high fiber content of feed is recommended in the feed i.e. hay, oats and corn silage as opposed to a high energy diet of wheat and barley. The use of hormones as milk promoters e.g. rumensen, Bst is not recommended.

As noted above, the feed and method of the present invention is particularly suited for ruminants, which include cattle, goats and sheep. Chickens will also benefit from this feed supplement and added natural ingredient/coating mix. As noted previously, chickens benefit by having elevated LCP's (DHA) in the yolk of eggs and in the meat. Additional benefit is reduced infection and disease.

Milk, meat and processed products e.g. cheese, produced by this invention will have significant levels of beneficial omega 3/6 and long chain polyunsaturates such as DHA/EPA. In this further embodiment, the production of elevated essential fatty acids and the maintenance of such essential fatty acids in pasturized milk and/or processed products, was not demonstrated in prior art studies, which used only a feed supplement containing omega fatty acid ingredients without the uses of the natural ingredient/coating mix of the present invention. Although not wanting to be bound by any particular theory, it is believed that the essential fatty acids, which are produced for example in the milk or meat of animals fed according to the present invention, are associated with the natural fat in the milk and meat which remains stable, even though the products may be subjected to high temperature, for example, pasteurization or natural cooking. Pasteurization of milk usually follows a process of heating the milk to about 62.8° C., for half an hour or to about 72.8° C. for 15 seconds. This pasturized milk is usually stable, with refrigeration, for about 15 days. Ultra-pasteurization occurs at much higher temperature for a brief period of time. For example, normally ultra pasterization of milk occurs at about 141° C. for 1 to 2 seconds. Such milk is stable for approximately 60 days with refrigeration. This ultra-pasteurization process is also used in the production of ultra high temperature products, which are normally vacuum packed and can be stored for up to 90 days, without refrigeration. According to the present invention, the milk products pasteurized, as defined above, contain improved levels of the essential fatty acids. Similarly, meat processed temperatures as high as 230° C., or even higher, for 1 to 8 hours again maintain the elevated levels of essential fatty acids. In both cases, the fatty acids do not appear to be broken down during the processing stages and are thus stable in the milk and meat products.

The invention provides a number of benefits, including:

The production of elevated long chain polyunsaturates such as DHA/EPA naturally in the milk and dairy/food products such as cheese via the feed supplement and process that is palatable to livestock (e.g. cows, beef cattle, goats, poultry, horses, pets, etc.) and allows for elevated levels of nutraceutical components such as omega 3/6 and long chain polyunsaturates (LCP's) to occur in such animal and food products including livestock that have a rumen e.g. cows and beef cattle;

The production of palatable and effective feed supplements for livestock that result in elevated amounts of omega 3/6 and LPC's naturally in food products, ingredients and supplements;

The production of omega 3/6 fatty acids from plants either as fresh living plants and or as stabilized plant powder form as omega rich concentrates that can be used metabolically as feed/food ingredients alone or in combination with livestock fish meal/DHA/EPA marine or algae livestock supplements described herein;

The feed supplements provide health benefits to livestock, animals, etc. over standard diets including the production of healthier calves, shorter “dry periods” and general overall lengthening of “livestock life periods”;

The production of fresh or powdered plant products with elevated amounts of omega 3/6 fatty acids that can be used as stable ingredients to animal feed or human food without causing odour, taint or taste, stability or quality problems.

The farms on which the research was conducted to support this invention showed that the dairy cows fed the omega 3/6 rich feed supplement in a recommended feeding regime appeared healthier than cows on standard diets.

Moreover, the production of milk either in volume per cow or quality has remained the same or been enhanced. The milk produced from such farms has shown exceptional “cheese production characteristics” e.g. whiteness, ability to form excellent curds, unique taste, etc.

This invention will now be described with reference to specific examples, which are not to be construed as limiting.

### EXAMPLES

### Example 1

### Increased Concentrations of Long Chain Fatty Acids in the Milk of Holstein Cattle Fed with the Omega Fatty Acid Dietary Supplement

A total of 3 kg of omega fatty acid feed supplement was fed and top dressed with the magnesium silicate hydroxide and/or sodium bentonite. A total of 3 kg of the omega fatty acid food supplement was fed per day, half of this ration being fed at each of the two milking times, i.e., morning and evening. In this example, 3% to 8% of the natural ingredient/coating mix was added to the omega fatty acid feed supplement at each feeding. In this embodiment of the present invention, the omega fatty acid dietary supplement is as follows:

| | Kg. |
|---|---|
| Menhadden meal | 240 |
| Herring meal | 240 |
| Barley | 220 |
| Soy hulls | 232 |
| HC plus Premix | 25 |
| (specific mineral pre-mix) | |
| Herring fish oil | 20 |
| Hiboot salt | 10 |
| Vitamin E | 5 |
| Mag Ox | 4 |
| Vitamin ADE | 2 |
| Apple flavour | 2 |

The milk test results for specific cows from a research herd are shown below in the following Tables 1 to 4.

TABLE 1
(4 weeks after feeding supplement) Holstein cows:

| | Mg/100 gm (Milk) | | | | | |
|---|---|---|---|---|---|---|
| | 0 day | 4 Weeks | 0 day | 4 weeks | 0 day | 4 weeks |
| | Herd #1 | Herd #1 | Herd #2 | Herd #2 | Herd #1 | Herd #3 |
| EPA | 0.4 | 6.4 | 0.3 | 5.6 | 0.4 | 4.7 |
| DHA | 0.3 | 15.4 | 0.3 | 8.9 | 0.3 | 12.0 |
| Omega 3 | 12.0 | 45.6 | 11.0 | 34.7 | 12.0 | 39.2 |
| Omega 6 | 82.8 | 22.8 | 80.0 | 80.3 | 83.0 | 90.4 |
| % DHA | 0.03 | 0.46 | 0.03 | 0.3 | 0.03 | 0.34 |
| % Fat | 3.2 | 3.3 | 3.2 | 2.07 | 3.2 | 3.4 |

TABLE 2
(2 months after feeding supplement) Holstein cows Holstein Cows.

| | Mg/100 gm (Milk) | | | | | |
|---|---|---|---|---|---|---|
| | 0 day | 60 days | 0 day | 60 days | 0 day | 60 days |
| | Herd #1 | Herd #1 | Herd #2 | Herd #2 | Herd #3 | Herd #3 |
| EPA | 0.1 | 8.5 | 0.2 | 11.0 | 0.2 | 7.0 |
| DHA | 0.08 | 15.2 | 0.1 | 16.7 | 0.1 | 12.4 |
| Omega 3 | 10.0 | 52.8 | 10.0 | 67.2 | 10.0 | 51.2 |
| Omega 6 | 87.0 | 74.9 | 80.0 | 78.3 | 82.0 | 74.8 |
| % DHA | 0.01 | 0.5 | 0.01 | 0.5 | 0.01 | 0.4 |
| % Fat | 3.2 | 3.2 | 3.3 | 3.3 | 3.2 | 3.1 |

TABLE 3
(3 months after feeding supplement) Holstein Cows

| | Mg/100 gm (Milk) | | | | | |
|---|---|---|---|---|---|---|
| | 0 day | 90 days | 0 day | 90 days | 0 day | 90 days |
| | Herd #1 | Herd #1 | Herd #2 | Herd #2 | Herd #3 | Herd #3 |
| EPA | 0.4 | 6.6 | 0.4 | 6.6 | 0.2 | 6.00 |
| DHA | 0.2 | 14.00 | 0.3 | 11.00 | 0.1 | 10.00 |
| Omega 3 | 12.0 | 39.00 | 12.0 | 38.00 | 10.0 | 35.41 |
| Omega 6 | 80.5 | 64.20 | 83.0 | 55.00 | 82.0 | 72.00 |

TABLE 4
(4 months after feeding supplement) Holstein Cows Holstein cows
Mg/100 gm (Milk)

| | | | | | | 120 |
|---|---|---|---|---|---|---|
| | 0 day | 120 days | 0 day | 120 days | 0 day | days |
| | Herd #1 | Herd #1 | Herd #2 | Herd #2 | Herd #3 | Herd #3 |
| EPA | 0.4 | 8.5 | 0.4 | 11.00 | 0.2 | 7.0 |
| DHA | 0.2 | 15.2 | 0.3 | 16.7 | 0.1 | 12.4 |
| Omega 3 | 11.0 | 52.8 | 12.0 | 67.2 | 10.0 | 51.2 |
| Omega 6 | 88.0 | 74.9 | 83.0 | 78.3 | 82.0 | 74.8 |
| % DHA | 0.02 | 0.5 | 0.03 | 0.5 | 0.01 | 0.4 |
| % Fat | 3.2 | 3.2 | 3.2 | 3.3 | 3.2 | 3.1 |

In all of the tables shown above, the concentration of the essential fatty acids at 0 day are the results with milk produced from cattle fed with conventional feed. In these trials, attempts were made to feed the cattle omega 3 supplement, however the cows refused to eat such a supplement due to the taste and smell of the omega 3 feed supplement. However, mixed with the natural ingredient/coating mix of the present invention, the cattle did eat the omega 3 feed supplement.

### Example 2

### Increased Concentrations of Long Chain Fatty Acids in the Milk of Goats Fed with the Omega Fatty Acid Dietary Supplement

A total of 3 kg of omega fatty acid feed supplement was fed and top dressed with the magnesium silicate hydroxide and/or sodium bentonite. A total of 3 kg of the omega fatty acid food supplement was fed per day, half of this ration being fed at each of the two milling times, i.e., morning and evening. In this example, 3% to 8% of the natural ingredient/coating mix was added to the omega fatty feed supplement at each feeding. In this embodiment of the present invention, the omega fatty acid dietary supplement is as follows:

| | Kg. |
|---|---|
| Menhadden meal | 240 |
| Herring meal | 240 |
| Or combinations of DHA/EPA microencapsulated | |
| Fish oil (30EPA/20DHA) or combinations of | |
| NutraSprout (trademark) flax/algae powder that | |
| maintain DHA/EPA | |
| Omega 3/6 levels the same as Menhadden and | |
| Herring meal. | |
| Barley | 140 |
| Soy hulls | 232 |
| Alfalfa or quackgrass brome grass | 40 |
| Kelp | 40 |
| HC plus Premix (specific mineral pre-mix) | 25 |
| Hiboot salt | 10 |
| Vitamin E | 5 |
| Mag Ox | 4 |
| Vitamin ADE | 2 |
| Apple flavour | 2 |

The milk test results for specific goats from a research herd are shown below in the following Table 5.

TABLE 5
Goat Milk Results (One month after feeding)
Mg/100 gm (Milk)

| | 0 day | Herd #1 | Herd #2 | Herd #3 |
|---|---|---|---|---|
| EPA | 1.08 | 3.18 | 3.75 | 3.7 |
| DHA | 0.43 | 5.05 | 6.27 | 6.3 |
| Omega 3 | 13.76 | 29.81 | 37.71 | 37.8 |
| Omega 6 | 73.85 | 64.28 | 67.87 | 67.9 |
| % DHA | 0.02 | 0.20 | 0.21 | 0.22 |
| % Fat | 2.5 | 2.67 | 2.93 | 2.94 |

### Example 3

### Levels of Long Chain Fatty Acids Found in Dairy Products Made From Fresh Milk From Dairy Cattle

The milk obtained from the Holstein cows, in accordance with Example 1, was used to produce dairy products such as cheese, yogurt, ice cream, curds, and sour cream. These products also showed an enhanced level of the essential fatty acids, i.e., DHA/EPA. Fatty acid results from the seven different batches of cheese produced from milk from Example 1 is shown below in Table 6.

TABLE 6
Omega 3 enriched Cheese Results (after 2 month storage)

| | Mg/100 g (cheese) | | | | | | |
|---|---|---|---|---|---|---|---|
| | Cheese | Cheese | Cheese | Cheese | Cheese | Cheese | Cheese |
| | Lot #1 | Lot #2 | Lot #3 | Lot #4 | Lot #5 | Lot #6 | Lot #7 |
| EPA | 19.8 | 20.2 | 55.0 | 60.1 | 62.4 | 53.0 | 55.0 |
| DHA | 104.0 | 104.0 | 121.0 | 120.4 | 117.2 | 100.00 | 117.0 |
| Ome- | 351.0 | 381.0 | 506.0 | 500.00 | 511.0 | 490.0 | 525.0 |
| ga 3 | | | | | | | |
| Ome- | 1570.0 | 1652.0 | 980.0 | 885.0 | 947.0 | 959.0 | |
| ga 6 | | | | | | | |
| % | 0.40 | 0.40 | 0.40 | 0.40 | 0.40 | 0.36 | 0.38 |
| DHA | | | | | | | |
| % Fat | 26.8 | 28.3 | 31.0 | 30.0 | 31.3 | 29.2 | 31.0 |
| CLA | 183.0 | 159.0 | 180.0 | 175.0 | 140.0 | 180.0 | 200 |

Controlled levels of beneficial omega 3 fatty acids normally occurring in either goat cheddar or dairy cheddar cheese is shown below in Table 7.

TABLE 7
Regular Cheeses (Non enriched)

| | Goat Cheddar (white) | Medium Cheddar (cow) |
|---|---|---|
| EPA | 11.89 | 13.6 |
| DHA | 6.9 | 20.42 |
| Omega 3 | 192.0 | 233.60 |
| Omega 6 | 718.3 | 846.8 |
| % DHA | 0.04 | 0.07 |
| % Fat | 19.33 | 27.4 |

### Example 4

### Concentration of Essential Fatty Acids in Meat From Animals Fed with the Omega Fatty Acid Supplement

In a further aspect of the present invention, the level of beneficial omega fatty acids was found to be increased in the meat from animals fed with the omega fatty acid dietary supplement according to the present invention.

Results from a number of different carcases from animals fed for 8 weeks on the dietary supplement of the present invention, is shown below in Tables 8 and 9.

TABLE 8
Meat Results - Veal (8 weeks after feeding)

| | Mg/100 g | | | | | | |
|---|---|---|---|---|---|---|---|
| | | Meat | Meat | Meat | Meat | Meat | Meat |
| | | Sample | Sample | Sample | Sample | Sample | Sample |
| | Day 0 | #1 | #2 | #3 | #4 | #5 | #6 |
| EPA | 0 | 25.0 | 18.0 | 21.0 | 20.9 | 21.0 | 15.0 |
| DHA | 0.01 | 14.9 | 12.9 | 11.3 | 12.6 | 13.2 | 10.0 |
| Ome- | 0.14 | 84.0 | 82.0 | 67.1 | 65.0 | 66.4 | 54.4 |
| ga 3 | | | | | | | |
| Ome- | 260 | 269 | 72 | 59 | 200 | 201 | 200 |
| ga 6 | | | | | | | |
| % | 0 | 0.47 | 0.25 | 0.48 | 0.60 | 0.4 | 0.5 |
| DHA | | | | | | | |
| % Fat | 3.4 | 3.4 | 5.6 | 2.3 | 2.1 | 3.0 | 2.0 |

TABLE 9
Meat Results - Beef (8 weeks after feeding)
Mg/100 g

| | | Meat Sample | Meat Sample | Meat Sample |
|---|---|---|---|---|
| | Day 0 | #1 | #2 | #3 |
| EPA | 0 | 21.0 | 21.2 | 16.3 |
| DHA | 0.01 | 14.0 | 14.6 | 14.2 |
| Omega 3 | 0.15 | 65.5 | 80.1 | 82.7 |
| Omega 6 | 200 | 204.0 | 290.0 | 338.0 |
| % DHA | 0 | 0.5 | 0.3 | 0.2 |
| % Fat | 4.0 | 2.7 | 5.0 | 8.3 |

### Example 5

### Concentration of Essential Fatty Acids in Eggs From Poultry Fed with the Omega Fatty Acid Supplement

In a further embodiment of the present invention, it was found that hens fed with the dietary supplement of the present invention showed an increase concentration of omega 3 fatty acids in the resulting eggs. Rations fed to hens included total mix of 0.1 to 0.2 kg/day to general feed ration per hen. The coating used was 100-300 g of coating mix in 0.1 to 0.2 kg of sprouted (Nutraflax) powder.

The concentration of beneficial omega fatty acids resulting in eggs from poultry after three weeks of feeding with the omega fatty acid dietary supplement of the present invention. These results are shown below in Table 10.

TABLE 10
Poultry Results (eggs three weeks after feeding)

| | Mg/100 g (Hens) | | | | | |
|---|---|---|---|---|---|---|
| | | Sample | Sample | Sample | Sample | Sample |
| | Day 0 | #1 | #2 | #3 | #4 | #5 |
| EPA | | 4.0 | 4.0 | 5.0 | 4.4 | 4.6 |
| DHA | | 115 | 112 | 116 | 113 | 120 |
| Omega 3 | | 180 | 185 | 174 | 178.3 | 180 |
| Omega 6 | | 1184 | 1356 | 1137 | 1291 | 1300 |
| % DHA | 0.08 | 1.22 | 1.02 | 1.27 | 1.14 | 1.20 |
| % Fat | 9.3 | 9.41 | 10.26 | 9.22 | 9.92 | 9.24 |

### Example 6

### Essential Fatty Acids Stable in Processed Milk Products Following Heat Treatment.

The milk products produced according to the present invention, for example, milk or cheese, were further processed which demonstrates the stability of the essential fatty acids contained in the enriched milk of the present invention.

For example, milk produced from Holstein cattle fed with the feed supplement of the present invention, was pasteurized and the concentration of essential fatty acids retested. These results are shown below in Table 11, which shows that the essential fatty acids were stable, even following pasteurization treatment.

TABLE 11
Milk, Pasteurized Milk

| | mg/100 g (milk) | | | | | |
|---|---|---|---|---|---|---|
| | Sample | Sample | Sample | Sample | Sample | Sample |
| | #1 | #2 | #3 | #4 | #5 | #6 |
| EPA | 10.0 | 8.2 | 6.6 | 6.2 | 8.4 | 9.1 |
| DHA | 15.4 | 15.2 | 14.0 | 11.0 | 15.2 | 16.7 |
| Omega 3 | 67.2 | 52.7 | 39.0 | 38.0 | 67.0 | 36.3 |
| Omega 6 | 74.9 | 78.3 | 64.2 | 55.0 | 72.0 | 82.0 |
| % DHA | 0.5 | 0.5 | 0.4 | 0.3 | 0.5 | 0.5 |
| % Fat | 3.2 | 3.3 | 3.2 | 3.2 | 3.3 | 3.1 |

The cheese produced by the present invention, from Holstein cattle, fed with the feed supplement, was further processed by heating to produce a cheese melt. The cheese was heated at 230° C. for 1 to 2 minutes. Following this heat treatment, the cheese was retested for the concentration of the essential amino acids. These results can be found below in Table 12, where it is noted that the essential fatty acids are stable, despite the heat processing.

TABLE 12
Cheese Melted (Ultra Heat 230° C. for 1-2 minutes)

| | mg/100 g | | |
|---|---|---|---|
| | Cheese Lot #1 | Cheese Lot #2 | Cheese Lot #3 |
| EPA | 55.0 | 60.1 | 62.4 |
| DHA | 121 | 120.4 | 117.2 |
| Omega 3 | 506 | 500 | 511.0 |
| Omega 6 | 980 | 885.0 | 947.0 |
| % DHA | 0.4 | 0.4 | 0.40 |
| % Fat | 31.0 | 30.1 | 31.3 |
| CLA | 180 | 175.0 | 140.0 |

All references referred to herein are incorporated by reference.

This invention will now be defined with respect to particular claims, which are not to be construed as limiting.

1: A feeding additive for livestock comprising:
a) essential fatty acids; and
b) a natural ingredient selected from the group consisting of talc and clay wherein said natural ingredient is present in the feed in an amount sufficient to increase the concentration of the essential fatty acids in the milk, eggs or meat of the animal fed with the feed additive over a period of time.

2: The feed additive according to claim 1 wherein said essential fatty acid is selected from the group consisting of omega 3 fatty acid and omega 6 fatty acid.

3: The feed additive according to claim 1 wherein said essential fatty acid is selected from the group consisting of, docasahexaenioc acid, eicosapentenoic acid, linoleic acid and alpha-linolenic acid.

4: The feed additive according to claim 1 wherein said feed additive is fed to the animal together with a high fibre diet.

5: The feed additive according to claim 1 wherein the essential fatty acid is obtained from the group consisting of fish, plant and algae.

6: The feed additive according to claim 1 wherein the feed additive further comprises flavouring to increase the taste and palatability of the feed additive.

7: The feed additive according to claim 1 wherein the essential fatty acid component of the feed additive comprises the following:

| | Kg. |
|---|---|
| Menhadden meal | 150-300 |
| Herring meal | 150-300 |
| Barley | 150-250 |
| Soy hulls | 170-250 |
| HC plus Premix | 20-30 |
| (specific mineral pre-mix) | |
| Herring fish oil | 16-24 |
| Hiboot salt | 8-12 |
| Vitamin E | 4-6 |
| Mag Ox | 3.2-4.8 |
| Vitamin ADE | 1.6-2.4 |
| Apple flavour | 1.6-2.4. |

8: The feed additive according to claim 1 wherein the natural ingredient further comprises a flax powder product containing 20 to 25% w/w alpha linolenic acid in a dry stable form, 0.5 to 1% moisture.

9: A method of producing milk, eggs or meat of animal which is enriched for essential fatty acids comprising feeding an animal a feed additive as defined in claim 1 in an amount sufficient to enhance the concentration of essential fatty acids in the milk, eggs or meat and collecting the milk, eggs or meat from said animal.

10: Enriched milk from ruminant animals produced by the process of claim 9.

11: A milk product produced by the milk of claim 10.

12: The milk product of claim 10 wherein said milk product is selected from the group consisting of buttermilk, eggnog, flavoured milk beverages, milk by-products including cheese, sour cream, cheese curd, cream, butter, yogurt or milk powder.

13: A meat or processed meat product produced from animals according to the process of claim 9.

14: A milk product produced by the process of claim 9 that results in a stable amount of essential fat acids in the milk product, following pasteurization.

15: The milk product of claim 14 wherein the pasteurization occurs by a process selected from the group consisting of: heating to about 62.8° C. for about half an hour, heating to about 72.8° C. for about 15 seconds and heating to about 141° C. for about 1 to 2 seconds.

16: A meat product from animals according to the process of claim 9 that results in a stable amount of essential fatty acids in the meat product, following cooking or heating.

17: The meat product according to claim 16 wherein the meat is cooked or heated for about 1 to 8 hours at about 230° C.
